(19) United States
(12) Patent Application Publication
(10) Pub. No.: US 2006/0005888 A1
(43) Pub. Date: Jan. 12, 2006

(54) Flow control apparatus

(76) Inventor: Chung-I Huang, Ho Mei Town (TW)

Correspondence Address: CHARLES E. BAXLEY, ESQ., 90 JOHN STREET, THIRD FLOOR, NEW YORK, NY, 10038, US

(21) Appl. No.: 10/890,439

(22) Filed: Jul. 12, 2004

(51) Int. Cl. F16K 3/00

(52) U.S. Cl. 137/625.31

(57) ABSTRACT

A flow control apparatus includes a housing. A valve is rotationally installed in the housing. A bolt includes a first end connected with the valve in the housing and an opposite second end inserted to the exterior of the housing. A joint is connected with the housing in order to keep the valve in the housing.

### BACKGROUND OF INVENTION

1. Field of Invention

The present invention relates to a flow control apparatus.

2. Related Prior Art

Referring to FIG. 6, a conventional flow control apparatus 100 includes a housing 110. The housing 110 defines an aperture 114. A valve 130 is rotationally installed in the housing 110. A shaft 140 extends to the exterior from the interior of the housing 110 through the aperture 114. The shaft 140 is connected with the valve 103 at an end and connected with a lever 150 at an opposite end. A joint 120 is connected with the housing 110 so that the valve 130 is kept in the housing 110. Pivotal of the lever 150 causes rotation of the valve 130. The lever 150 is however to long to fit in limited spaces.

The present invention is therefore intended to obviate or at least alleviate the problems encountered in prior art.

### SUMMARY OF INVENTION

According to the present invention, a flow control apparatus includes a housing. A valve is rotationally installed in the housing. A bolt includes a first end connected with the valve in the housing and an opposite second end inserted to the exterior of the housing. A joint is connected with the housing in order to keep the valve in the housing.

The primary advantage of the flow control apparatus according to the present invention is a small profile and therefore easy maneuvering in limited space.

Other objects, advantages and novel features of the present invention will become more apparent from the following detailed description referring to the attached drawings.

### BRIEF DESCRIPTION OF DRAWINGS

The present invention will be described through detailed illustration of the preferred embodiment referring to the drawings.

FIG. 1 is a perspective view of a flow control apparatus according to the preferred embodiment of the present invention.

FIG. 2 is an exploded view of the flow control apparatus shown in FIG. 1.

FIG. 3 is a cross-sectional view of the flow control apparatus shown in FIG. 1.

FIG. 4 is a cross-sectional view of the flow control apparatus in another position than that is shown in FIG. 3.

FIG. 5 is a reduced perspective view of the flow control apparatus shown in FIG. 1 in use.

FIG. 6 is an exploded view of a conventional flow control apparatus.

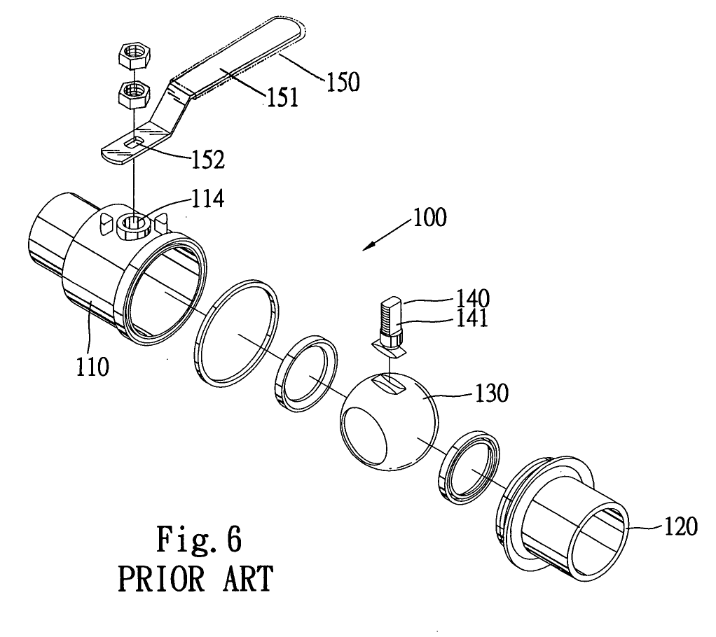

### DETAILED DESCRIPTION OF PREFERRED EMBODIMENT

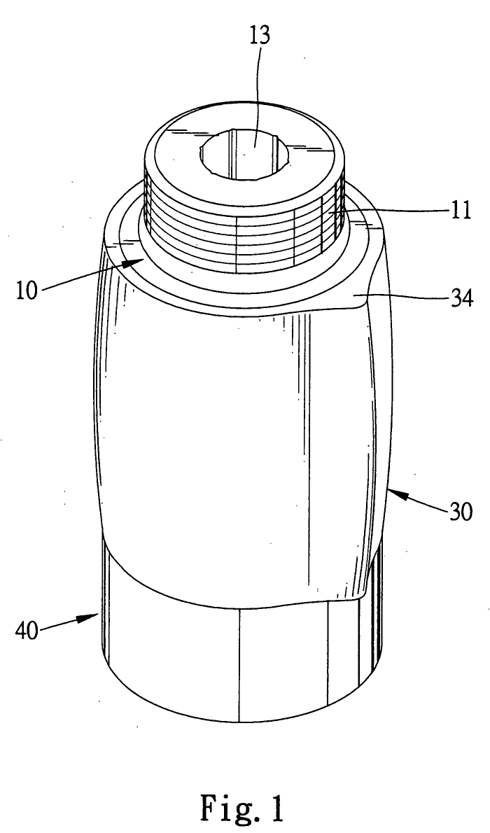

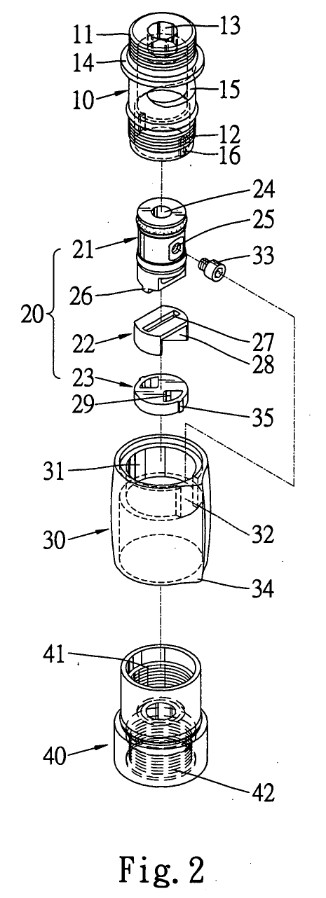

Referring to FIGS. 1 and 2, according to the preferred embodiment of the present invention, a flow control apparatus includes a housing 10, a valve 20 rotationally installed in the housing 10, a bolt 33 connected with the valve 20 in the housing 10, a grip 30 rotationally installed on the housing and connected with the bolt 33 outside the housing 10 and a joint 40 connected with the housing 10 so that the valve 20 is kept in the housing 10.

An axial passage 13 extends through the housing 10. The housing 10 includes a thread 11 extending thereon near an end, a thread 12 extending thereon near an opposite end, an annular flange 14 formed thereon, a peripheral slot 15 defined therein near the annular flange 14, and two recesses 16 defined in the wall of the axial passage 13.

The valve 20 includes a shaft 21 rotationally installed in the housing 10, a rotational element 22 connected with the shaft 21 in the housing 10, and a non-rotational element 23 installed in the housing 10.

An axial passage 24 extends through the shaft 21. The shaft 21 includes a peripheral hole 25 defined therein and a ridge 26 formed at an end thereof across the axial passage 24.

The rotational element 22 includes a groove 27 defined in an upper side and two sector-shaped blocks 28 formed on a lower side.

The non-rotational element 23 includes two sector-shaped apertures 29 defined therein and two protrusions 35 formed on the periphery thereof.

The grip 30 includes a space 31 defined therein, a recess 32 defined in an internal side thereof and a ridge 34 formed on an external side thereof.

The joint 40 is hollow, i.e., it includes an internal side and an external side. On the internal side of the joint 40 are formed a first thread 41 near an end and a second thread 42 near an opposite end.

In assembly, the shaft 21 is put in the housing 10. A bolt 33 is driven into the peripheral hole 25 of the shaft 21 through the peripheral slot 15 of the housing 10. Thus, the shaft 21 can be rotated by means of operating the bolt 33. The rotational element 22 is put in the housing 10. The ridge 26 of the shaft 21 is put in the groove 27 of the rotational element 22. Thus, the rotation of the shaft 21 causes rotation of the rotational element 22. The non-rotational element 23 is put in the housing 10. The protrusions 35 of the non-rotational element 23 are put in the recesses 16 of the housing 10. Thus, rotation of the non-rotational element 23 relative to the housing 10 is prevented. The grip 30 is put around the housing 10. The bolt 33 is put in the recess 32 of the grip 30.

Thus, the bolt 33 can be pivoted by means of rotating the grip 30. The ridge 34 makes it easy for a user to rotate the grip 30. The first thread 41 of the joint 40 is engaged with the second thread 12 of the housing 10. Thus, the valve 20 is retained in the housing 10, and the grip 30 around the housing 10.

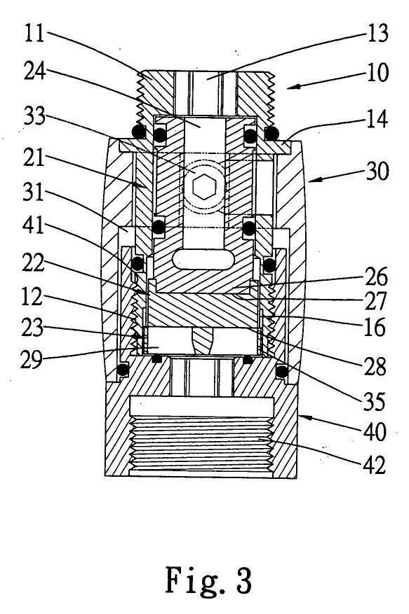

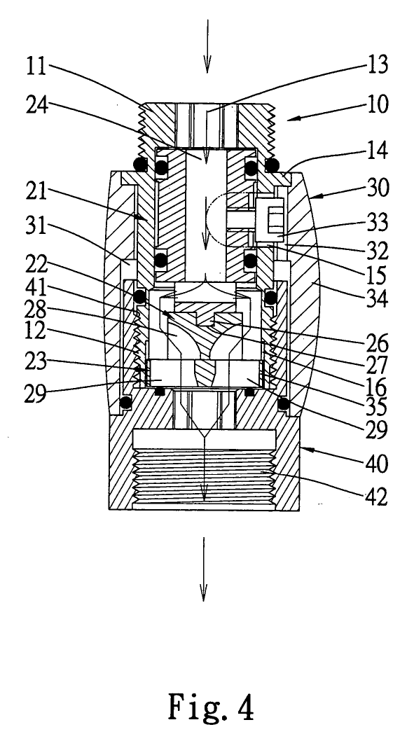

As the rotational element 22 can be rotated relative to the non-rotational element 23, the sector-shaped blocks 28 of the rotational element 22 can block or open the sector-shaped apertures 29 of the non-rotational element 23 as shown in FIGS. 3 and 4, respectively.

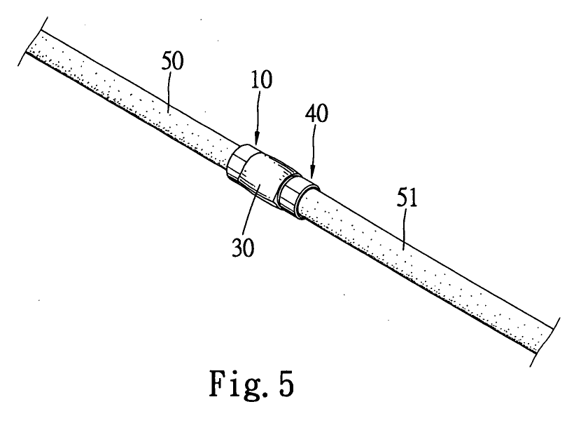

Referring to FIG. 5, the housing 10 can be connected with a hose 50, and the joint 40 can be connected with another hose 51. Thus, the flow of liquid to the hose 51 from the hose 50 is controlled by means of the flow control apparatus according to the present invention.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A flow control apparatus comprising a housing, a valve rotationally installed in the housing, a bolt comprising a first end connected with the valve in the housing and an opposite second end inserted to the exterior of the housing, and a joint connected with the housing in order to keep the valve in the housing.

2. The flow control apparatus according to claim 1 wherein the housing comprises a peripheral slot through which the bolt extends.

3. The flow control apparatus according to claim 1 wherein the valve comprises:
a shaft rotationally put in the housing and connected with the bolt;
a rotational element connected with the shaft in the housing, the rotational element comprising at least one block formed thereon; and
a non-rotational element put in the housing, the non-rotational element comprising at least one aperture defined therein, wherein the aperture can be blocked or opened by means of the block.

4. The flow control apparatus according to claim 3 wherein the block of the rotational element is sector-shaped, wherein the aperture of the non-rotational element is sector-shaped.

5. The flow control apparatus according to claim 3 wherein the rotational element comprises two blocks, wherein the non-rotational element comprises two apertures.

6. The flow control apparatus according to claim 3 wherein the shaft comprises an axial passage extending through the shaft.

7. The flow control apparatus according to claim 3 wherein the shaft includes a peripheral hole for receiving the bolt.

8. The flow control apparatus according to claim 3 wherein the shaft comprises a ridge formed thereon, wherein the rotational element comprises a groove defined therein for receiving the ridge.

9. The flow control apparatus according to claim 3 wherein the non-rotational element comprises at least one protrusion formed thereon, wherein the housing comprises at least one recess defined in an internal side for receiving the protrusion.

10. The flow control apparatus according to claim 9 wherein the non-rotational element comprises two protrusions, wherein the housing comprises two recesses.

11. The flow control apparatus according to claim 1 comprising a grip rotationally put around the housing and connected with the second end of the bolt.

12. The flow control apparatus according to claim 11 wherein the grip comprises a recess defined in an internal side thereof for receiving the bolt.

13. The flow control apparatus according to claim 11 wherein the grip comprises a ridge formed on an external side thereof.
